(19) United States
(12) Patent Application Publication
(10) Pub. No.: US 2020/0301315 A1
(43) Pub. Date: Sep. 24, 2020

(54) DEVELOPING DEVICE AND IMAGE FORMING APPARATUS

(71) Applicant: TOSHIBA TEC KABUSHIKI KAISHA, Tokyo (JP)

(72) Inventors: Masayuki Kasukawa, Misato Saitama (JP); Hirotaka Fukuyama, Mishima Shizuoka (JP)

(21) Appl. No.: 16/358,839

(22) Filed: Mar. 20, 2019

(51) Int. Cl. G03G 15/08; G03G 15/09

(52) U.S. Cl. CPC G03G 15/0889; G03G 15/0921

(57) ABSTRACT

According to one embodiment, a developing device includes a developer storage unit, a magnet roller, a first stirring screw, and a second stirring screw. The developer storage unit is configured to be made to be able to circulate and convey a developer. The first stirring screw conveys the developer from a second opening portion to a first opening portion along a longitudinal direction. The first stirring screw includes a rotating shaft and a protrusive ridge. The protrusive ridge spirally swirls around the rotating shaft. A plurality of notches are formed in part of the protrusive ridge. The phases of the plurality of notches in the circumferential direction of the rotating shaft at respective central positions in the plurality of notches are shifted in the axial direction. The second stirring screw conveys the developer from the first opening portion to the second opening portion along the longitudinal direction.

### FIELD

Embodiments described herein relate generally to a developing device, an image forming apparatus, and methods related thereto.

### BACKGROUND

A developing device of an image forming apparatus stirs a developer containing a toner and a carrier, thereby triboelectrically charging the toner. The charged toner is adsorbed on a magnet roller and thereafter moves to a photoconductive drum.

In this manner, the developing device causes the toner contained in the developer to adhere to the photoconductive drum according to an electrostatic latent image. When the toner is consumed by development, the toner is supplied to the developing device. The developing device includes a stirring screw. The stirring screw stirs the developer and the supplied toner, and also circulates and conveys the developer in the developing device.

The stirring screw more preferably equalizes the charge amount of the toner and the distribution density of the toner. The stirring screw needs to uniformly feed a necessary amount of the developer to the magnet roller. The stirring screw needs to have excellent stirring performance and conveying performance.

For example, in order to improve the stirring performance of the stirring screw, a notch is known to be provided to the screw. However, when a notch is provided, the rigidity and uniformity of the stirring screw are deteriorated, and therefore, uneven development easily occurs. When the screw is not provided with a notch, the conveying performance becomes stable, however, the stirring performance is deteriorated.

### DESCRIPTION OF THE DRAWINGS

FIG. 1 is a schematic cross-sectional view showing an overall configuration example of an image forming apparatus of an embodiment.

FIG. 2 is a cross-sectional view showing an example of a principal portion of a developing device of an embodiment.

FIG. 3 is an A-A cross-sectional view in FIG. 2.

FIG. 4 is a B-B cross-sectional view in FIG. 2.

FIG. 5 is a schematic perspective view showing an example of a first stirring screw of the developing device of the embodiment.

FIG. 6 is a schematic perspective view showing an example of the first stirring screw of the developing device of the embodiment.

FIGS. 7A and 7B are cross-sectional views in FIG. 5.

FIG. 8 is a schematic cross-sectional view illustrating an act of the developing device of the embodiment.

FIG. 9 is a schematic perspective view showing an example of a first stirring screw of a first modification of the embodiment.

FIGS. 10A to 10D are schematic cross-sectional views in FIG. 9.

FIG. 11 is a schematic cross-sectional view showing an example of a first stirring screw of a second modification of the embodiment.

FIG. 12 is a schematic cross-sectional view showing an example of a first stirring screw of a third modification of the embodiment.

FIG. 13 is a schematic cross-sectional view showing an example of a first stirring screw of a fourth modification of the embodiment.

FIG. 14 is a schematic cross-sectional view showing an example of a first stirring screw of a fifth modification of the embodiment.

### DETAILED DESCRIPTION

A developing device of an embodiment includes a developer storage unit, a magnet roller, a first stirring screw, and a second stirring screw. The developer storage unit includes a first storage chamber and a second storage chamber. The first storage chamber and the second storage chamber store a developer. In the first storage chamber and the second storage chamber, a first opening portion and a second opening portion are formed in both end portions in a longitudinal direction. The developer storage unit is configured to be made to be able to circulate and convey the developer through the first opening portion and the second opening portion. The magnet roller adsorbs the developer. The magnet roller is disposed extending in the longitudinal direction in an upper portion of the first storage chamber. The first stirring screw conveys the developer from the second opening portion to the first opening portion along the longitudinal direction. The first stirring screw includes a rotating shaft and a protrusive ridge. The rotating shaft is disposed along the longitudinal direction below the magnet roller inside the first storage chamber. The protrusive ridge swirls spirally around the rotating shaft. A plurality of notches are formed in part of the protrusive ridge. The plurality of notches are formed at positions where the phases in the circumferential direction of the rotating shaft at respective central positions in the plurality of notches are shifted in the axial direction. The second stirring screw is disposed parallel to the first stirring screw inside the second storage chamber. The second stirring screw conveys the developer from the first opening portion to the second opening portion along the longitudinal direction.

### Embodiments

Hereinafter, a developing device and an image forming apparatus of embodiments will be described with reference to the drawings.

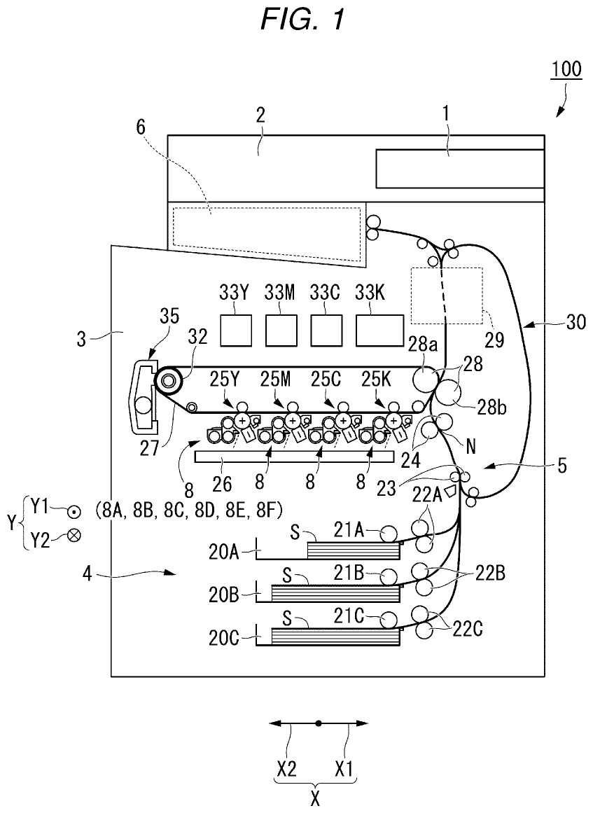

FIG. 1 is a schematic cross-sectional view showing an overall configuration example of an image forming apparatus of an embodiment. In the respective drawings hereinbelow, the same components are denoted by the same reference numerals unless otherwise specified.

As shown in FIG. 1, an image forming apparatus 100 of the embodiment includes a control panel 1, a scanner unit 2, a printer unit 3, a sheet feed unit 4, a conveying unit 5, and a body control unit 6.

Hereinafter, when referring to a relative position in the image forming apparatus 100, X1 direction, X2 direction, Y1 direction, and Y2 direction shown in the drawings are used in some cases. The X1 direction is a direction directed from left to right when standing in front of the image forming apparatus 100 (on the front side of the sheet of FIG. 1). The X2 direction is an opposite direction to the X1 direction. The Y1 direction is a direction directed from the rear face to the front face of the image forming apparatus 100. The Y2 direction is an opposite direction to the Y1 direction. When the direction is irrespective of the X1 (Y1) direction or the X2 (Y2) direction or both directions are included, the direction is simply referred to as “X (Y) direction”.

The control panel 1 makes the image forming apparatus 100 act by being operated by an operator.

The scanner unit 2 reads the image information of an object to be copied as the contrast of light. The scanner unit 2 outputs the read image information to the printer unit 3.

The printer unit 3 forms an image on a sheet S based on the image information from the scanner unit 2 or from the outside.

The printer unit 3 forms an output image (toner image) with a developer containing a toner. The printer unit 3 transfers the toner image onto the surface of the sheet S. The printer unit 3 applies heat and pressure to the toner image on the surface of the sheet S, thereby fixing the toner image to the sheet S.

The sheet feed unit 4 feeds the sheet S one by one to the printer unit 3 in accordance with the timing of forming the toner image by the printer unit 3.

The sheet feed unit 4 includes a plurality of paper feed cassettes 20A, 20B, and 20C. Each of the paper feed cassettes 20A, 20B, and 20C can store the sheets S whose size and type are set in advance for each cassette in a stacked state.

The paper feed cassettes 20A, 20B, and 20C can be attached to and detached from a body portion of the sheet feed unit 4. The paper feed cassettes 20A, 20B, and 20C are disposed in a stacked state in this order from the top to the bottom when being attached to the sheet feed unit 4.

The sheet feed unit 4 includes pickup rollers 21A, 21B, and 21C corresponding to the respective paper feed cassettes 20A, 20B, and 20C. The pickup rollers 21A, 21B, and 21C each pick up the sheet S loaded in the paper feed cassettes 20A, 20B, and 20C, respectively, one by one. The pickup rollers 21A, 21B, and 21C each pick up the uppermost sheet S in the loading direction among the loaded sheets S. The pickup rollers 21A, 21B, and 21C convey the picked up sheet S to the conveying unit 5 toward the printer unit 3.

The conveying unit 5 includes a conveying roller 23 and a resist roller 24. The conveying unit 5 conveys the sheet S fed from the pickup rollers 21A, 21B, and 21C to the resist roller 24. The resist roller 24 conveys the sheet S in accordance with the timing of transferring the toner image to the sheet S by the printer unit 3.

The conveying roller 23 abuts the front end in the conveying direction of the sheet S against a nip N of the resist roller 24. The conveying roller 23 bends the sheet S so as to adjust the position of the front end of the sheet S in the conveying direction.

The resist roller 24 aligns the front end of the sheet S sent from the conveying roller 23 in the nip N. Further, the resist roller 24 conveys the sheet S toward the below-mentioned transfer unit 28.

The printer unit 3 includes image forming units 25Y, 25M, 25C, and 25K, alight exposure unit 26, an intermediate transfer belt 27, a transfer unit 28, a fixing device 29, and a transfer belt cleaning unit 35.

The image forming units 25Y, 25M, 25C, and 25K are disposed in this order in the X1 direction.

Each of the image forming units 25Y, 25M, 25C, and 25K forms a toner image to be transferred to the sheet S on the intermediate transfer belt 27.

Each of the image forming units 25Y, 25M, 25C, and 25K has a photoconductive drum. The image forming units 25Y, 25M, 25C, and 25K form toner images of yellow, magenta, cyan, and black on the corresponding photoconductive drums 7, respectively.

On the circumference of each of the photoconductive drums 7, a charger, a developing device 8, a transfer roller, a cleaning unit, and a charge neutralizer are disposed. The transfer roller is opposed to the photoconductive drum 7. The intermediate transfer belt 27 is held between the transfer roller and the photoconductive drum 7. The light exposure unit 26 is disposed below the charger and the developing device.

A detailed configuration of each of the developing devices 8 will be described later.

Toner cartridges 33Y, 33M, 33C, and 33K are disposed above the image forming units 25Y, 25M, 25C, and 25K, respectively. In the toner cartridges 33Y, 33M, 33C, and 33K, toners of yellow, magenta, cyan, and black are stored, respectively.

The toner cartridges 33Y, 33M, 33C, and 33K communicate with the developing devices 8 of the image forming units 25Y, 25M, 25C, and 25K through the below-mentioned toner supply tubes 34 (not shown in FIG. 1).

In each of the toner cartridges 33Y, 33M, 33C, and 33K and the respective toner supply tubes 34, a toner conveying mechanism (not shown) for sending the toner to the developing device 8 is provided.

The respective toners in the toner cartridges 33Y, 33M, 33C, and 33K are supplied to the respective developing devices 8 through the toner supply tubes 34 (not shown).

The light exposure unit 26 irradiates a laser beam onto the surface of each of the charged photoconductive drums 7. The emission of the laser beam is controlled based on the image information. The light exposure unit 26 can also adopt a configuration in which LED light is irradiated in place of the laser beam.

The light exposure unit 26 is supplied with image information corresponding to each of yellow, magenta, cyan, and black.

The light exposure unit 26 forms electrostatic latent images based on the image information on the surfaces of the respective photoconductive drums 7.

The intermediate transfer belt 27 is composed of an endless belt. Tension is applied to the intermediate transfer belt 27 by a plurality of rollers abutting against the inner circumferential face. The intermediate transfer belt 27 is stretched into a flat shape. The inner circumferential face of the intermediate transfer belt 27 comes into contact with a support roller 28a at a position in the X1 direction farthest in the stretching direction. The inner circumferential face of the intermediate transfer belt 27 comes into contact with a transfer belt roller 32 at a position in the X2 direction farthest in the stretching direction.

The support roller 28a forms part of the below-mentioned transfer unit 28. The support roller 28a guides the intermediate transfer belt 27 at a secondary transfer position.

The transfer belt roller 32 guides the intermediate transfer belt 27 at a cleaning position.

On the lower face side in the drawing of the intermediate transfer belt 27, the image forming units 25Y, 25M, 25C, and 25K excluding the transfer rollers are disposed in this order in the X1 direction. The image forming units 25Y, 25M, 25C, and 25K are disposed spaced apart from one another in a region between the transfer belt roller 32 and the support roller 28a.

The respective developing devices 8 of the image forming units 25Y, 25M, 25C, and 25K store the developers containing the toners of yellow, magenta, cyan, and black, respectively. However, the developers 8 mutually have the same configuration except that the developers are different.

The respective developing devices 8 are disposed opposed in the X2 direction to the respective photoconductive drums 7 of the image forming units 25Y, 25M, 25C, and 25K. The respective developing devices 8 develop the electrostatic latent images formed on the photoconductive drums 7 which the respective developing devices 8 are opposed to. As a result, toner images are formed on the respective photoconductive drums 7.

The respective transfer rollers of the image forming units 25Y, 25M, 25C, and 25K transfer (primarily transfer) the toner images on the surfaces of the respective photoconductive drums 7 onto the intermediate transfer belt 27.

When the toner images reach primary transfer positions, a transfer bias is applied to the respective transfer rollers.

The respective cleaning units of the image forming units 25Y, 25M, 25C, and 25K remove the untransferred toner on the surfaces of the respective photoconductive drums 7 after the primary transfer by scraping or the like.

The respective charge neutralizers of the image forming units 25Y, 25M, 25C, and 25K irradiates light onto the surfaces of the respective photoconductive drums 7 after passing through the cleaning units. The respective charge neutralizers of the image forming units 25Y, 25M, 25C, and 25K neutralize the charge on the photoconductive drums 7 which the respective charge neutralizers are opposed to.

On the intermediate transfer belt 27, the transfer unit 28 is disposed at a position adjacent to the image forming unit 25K.

The transfer unit 28 includes the support roller 28a and a secondary transfer roller 28b. The secondary transfer roller 28b and the support roller 28a hold the intermediate transfer belt 27 therebetween. The position where the secondary transfer roller 28b and the intermediate transfer belt 27 come into contact with each other is a secondary transfer position.

The transfer unit 28 transfers the charged toner image on the intermediate transfer belt 27 onto the surface of the sheet S at the secondary transfer position. The transfer unit 28 applies a transfer bias to the secondary transfer position. The transfer unit 28 transfers the toner image on the intermediate transfer belt 27 to the sheet S by the transfer bias.

The fixing device 29 applies heat and pressure to the sheet S. The fixing device 29 fixes the toner image transferred to the sheet S by the heat and the pressure.

The transfer belt cleaning unit 35 is opposed to the transfer belt roller 32. The transfer belt cleaning unit 35 holds the intermediate transfer belt 27 therebetween. The transfer belt cleaning unit 35 scrapes the toner on the surface of the intermediate transfer belt 27. The transfer belt cleaning unit 35 collects the scraped toner in a waste toner tank.

The printer unit 3 includes a reversing unit 30. The reversing unit 30 reverses the sheet S discharged from the fixing device 29 by switchback. The reversing unit 30 conveys the reversed sheet S into a conveying guide on the upstream side of the resist roller 24 again. The reversing unit 30 reverses the sheet S for forming an image on the reverse side.

The body control unit 6 controls the respective device portions of the image forming apparatus 100. The control performed by the body control unit 6 includes control of stirring and conveying the developer in the respective developing devices 8.

Next, a detailed configuration of the developing device 8 will be described.

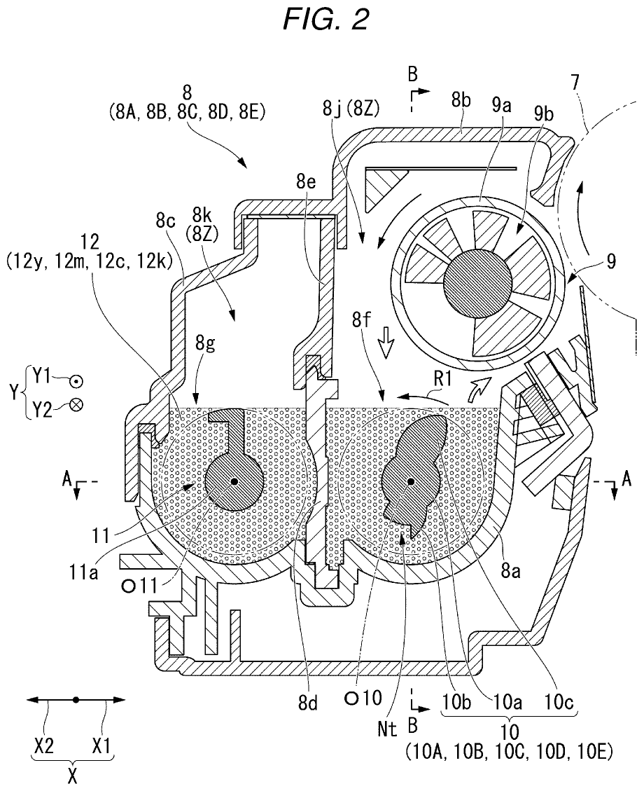

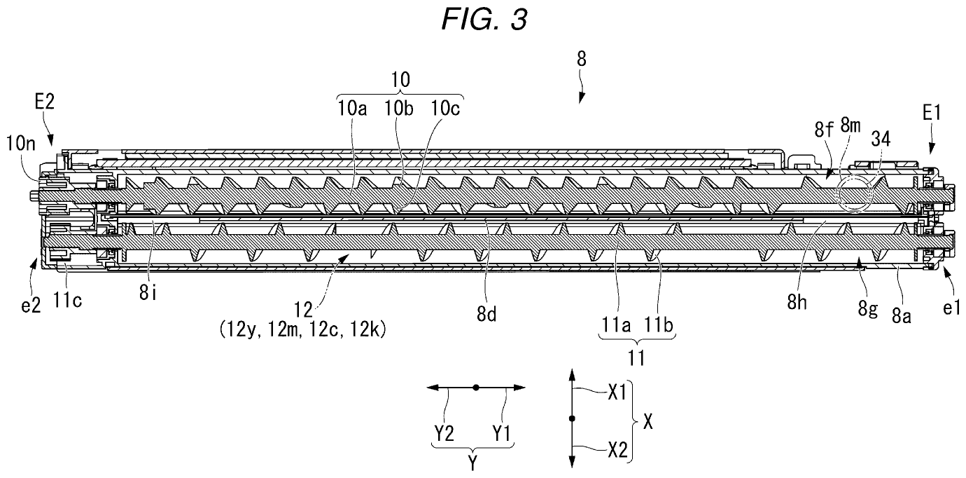

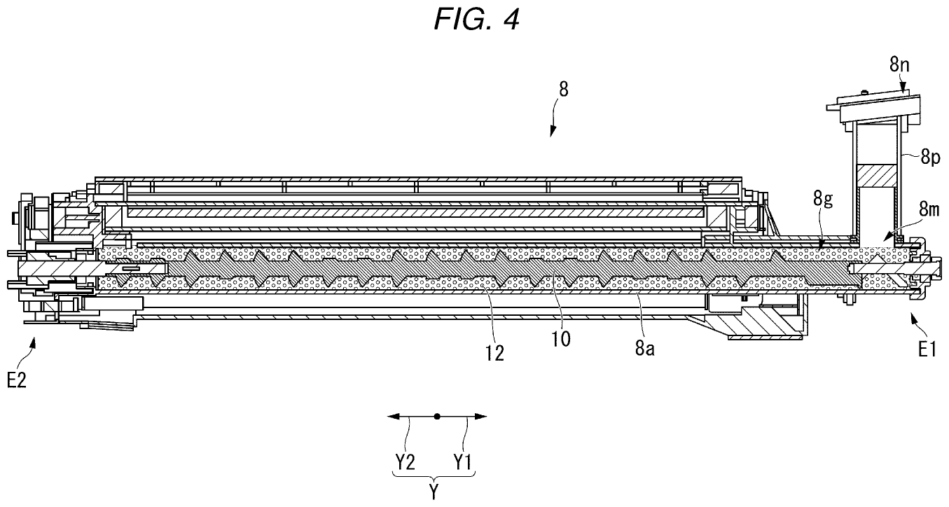

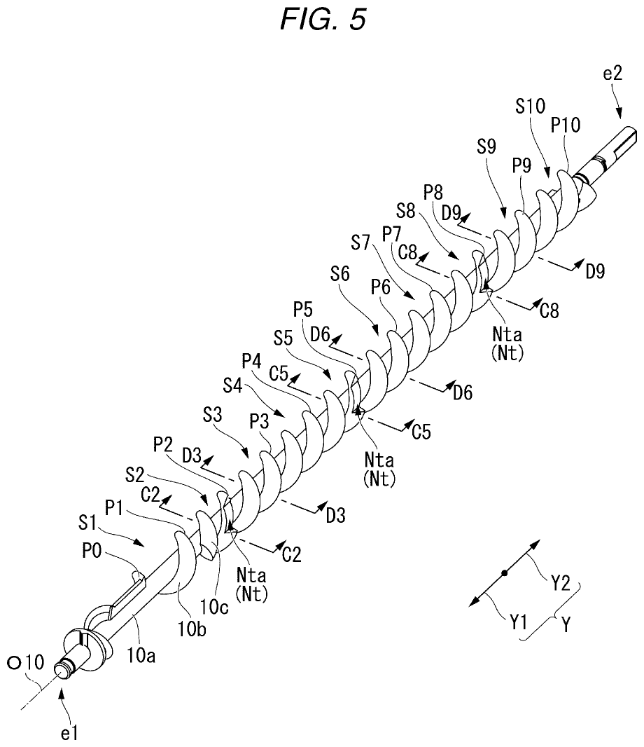

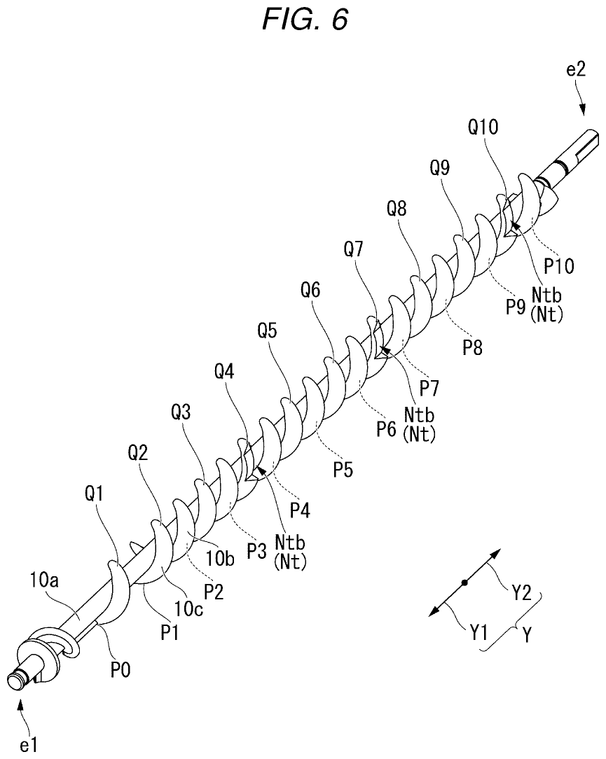

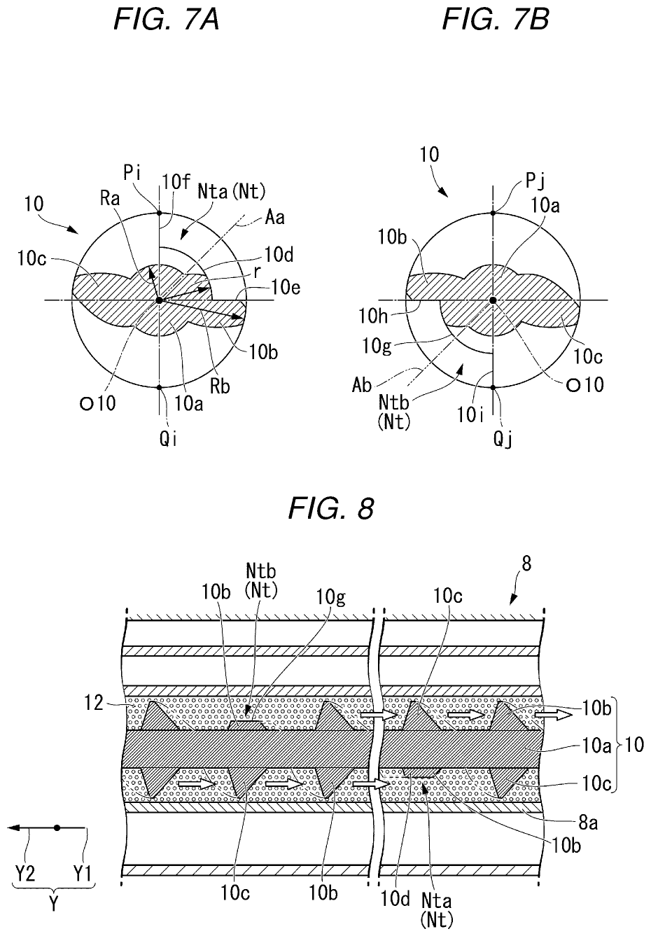

FIG. 2 is a cross-sectional view showing an example of a principal portion of the developing device of the embodiment. FIG. 3 is an A-A cross-sectional view in FIG. 2. FIG. 4 is a B-B cross-sectional view in FIG. 2. FIGS. 5 and 6 are each a schematic perspective view showing an example of a first stirring screw of the developing device of the embodiment. FIGS. 7A and 7B are cross-sectional views in FIG. 5. In particular, FIG. 7A is a Ci-Ci cross-sectional view in FIG. 5 (provided that i=2, 5, or 8). In particular, FIG. 7B is a Dj-Dj cross-sectional view in FIG. 5 (provided that j=3, 6, or 9).

The developing device 8 performs development by a two-component development system.

As shown in FIG. 2, the developing device 8 includes a developer storage container 8a, a magnet roller 9, an upper cover 8b, a left cover 8c, a first stirring screw 10, and a second stirring screw 11.

The developer storage container 8a is a container which is long in the Y direction (longitudinal direction). The developer storage container 8a opens upward. The developer storage container 8a stores, for example, a developer 12y, 12m, 12c, or 12k.

The developer 12y (12m, 12c, or 12k) is a mixture of a carrier composed of magnetic fine particles and a yellow (magenta, cyan, or black) toner. When the developer 12y (12m, 12c, or 12k) is stirred, the toner is triboelectrically charged. The toner is adhered to the surface of the carrier.

In the following description, when the color of the toner does not particularly need to be distinguished, any of the developers 12y, 12m, 12c, and 12k is denoted by “developer 12” for simplicity.

A first partition 8d is provided in a central portion in the X direction of the developer storage container 8a.

The first partition 8d divides a space in the developer storage container 8a into two parts in the X direction. According to this, groove portions 8f and 8g are lined up in this order in the X2 direction inside the developer storage container 8a. The cross section in the X direction of each of the groove portions 8f and 8g has a U-shaped form.

As shown in FIG. 3, the developer storage container 8a extends in the Y direction from a first end portion E1 to a second end portion E2 of the developing device 8. Here, the first end portion E1 is an end portion in the Y1 direction in the developing device 8. The second end portion E2 is an end portion in the Y2 direction in the developing device 8. However, in FIG. 3, for ease of viewing, illustration of the developer 12 is omitted.

Each of the first partition 8d and the groove portions 8f and 8g extends in the Y direction.

A first notch portion 8h (a first opening portion or an inflow portion of a toner) is formed in an end portion in the Y1 direction of the first partition 8d. The first notch portion 8h allows the groove portions 8f and 8g to communicate with each other. The developer 12y (12m, 12c, or 12k) in the groove portion 8f can move to the groove portion 8g through the first notch portion 8h.

A second notch portion 8i (a second opening portion) is formed in an end portion in the Y2 direction of the first partition 8d. The second notch portion 8i allows the groove portions 8f and 8g to communicate with each other. The developer 12y (12m, 12c, or 12k) in the groove portion 8g can move to the groove portion 8f through the second notch portion 8i.

As shown in FIG. 2, the magnet roller 9, the upper cover 8b, and the left cover 8c are disposed above the developer storage container 8a. The magnet roller 9, the upper cover 8b, and the left cover 8c are opposed to the opening on the upper side of the developer storage container 8a from above.

The magnet roller 9 supplies the developer 12 to the surface of the photoconductive drum 7. Further, the magnet roller 9 develops the electrostatic latent image on the surface of the photoconductive drum 7. The magnet roller 9 includes a cylindrical developing sleeve 9a and a magnet 9b disposed inside the developing sleeve 9a. The magnet 9b is provided with a magnetic field distribution for performing drawing-up, napping, and nap-cutting of the developer 12.

The magnet roller 9 has a wider developing width than the electrostatic latent image forming width of the photoconductive drum 7. The roller width of the magnet roller 9 is shorter than that of the developer storage container 8a.

The magnet roller 9 is disposed above the opening of the groove portion 8f. The surface of the developing sleeve 9a and the surface of the photoconductive drum 7 are in proximity to each other.

The magnet roller 9 is rotationally driven counterclockwise in the drawing by a developing motor (not shown). The magnet roller 9 is rotated by the developing motor so as to obtain a developing linear speed to be determined according to the linear speed of the photoconductive drum 7.

The upper cover 8b covers the surface of the magnet roller 9 excluding a portion coming close to the photoconductive drum 7 from above the groove portions 8f and 8g.

The left cover 8c covers a portion which is not covered with the upper cover 8b in the X2 direction and the Y direction above the developer storage container 8a and the groove portion 8g.

Between the upper cover 8b and the first partition 8d, a second partition 8e is disposed over substantially the same length as that of the first partition 8d.

The second partition 8e divides an internal space located above the developer storage container 8a and the first partition 8d and below the upper cover 8b and the left cover 8c into two parts in the X direction. Although an illustration is omitted, the second partition 8e closes the opening on the upper side of the first notch portion 8h and the second notch portion 8i.

In the developing device 8, the developer storage container 8a, the upper cover 8b, the left cover 8c, the first partition 8d, and the second partition 8e constitute a developer storage unit 8Z.

The developer storage unit 8Z has an internal space surrounded by the developer storage container 8a, the upper cover 8b, and the left cover 8c. The internal space is divided into two parts in the X direction by the first partition 8d and the second partition 8e. The developer storage unit 8Z is composed of a first storage chamber 8j including the groove portion 8f and a second storage chamber 8k including the groove portion 8g. The first storage chamber 8j and the second storage chamber 8k are lined up in this order in the X2 direction.

The first storage chamber 8j has a length capable of storing at least the magnet roller 9 in the Y direction.

The first storage chamber 8j is used for circulating the developer 12 between the groove portion 8f and the magnet roller 9. When the developer 12 is drawn up from the groove portion 8f by the magnet roller 9 (see an upward white arrow in the drawing), the developer 12 moves counterclockwise in the drawing with the rotation of the magnet roller 9. The developer 12 after completion of development moves to an upper part of the first storage chamber 8j with the rotation of the magnet roller 9. When the magnet roller 9 rotates so as to be opposed to the second partition 8e, the magnetic attraction of the developer 12 to the magnet roller 9 is released. The developer 12 drops on the groove portion 8f in the first storage chamber 8j by the own weight (see a downward white arrow in the drawing).

In this manner, in the first storage chamber 8j, the developer 12 circulates in the vertical direction. The first storage chamber 8j is separated from the second storage chamber 8k by the second partition 8e, and therefore, the developer 12 in the first storage chamber 8j is prevented from scattering to the second storage chamber 8k.

The second storage chamber 8k has a larger volume than the entire volume of the developer 12 stored in the developer storage container 8a. In an upper part of the groove portion 8g in the second storage chamber 8k, in an initial state of the developing device 8, an unused developer 12 is stored. The unused developer 12 is introduced into the developer storage container 8a by removing a seal (not shown) before starting to use the developing device 8.

As shown by a two-dot chain line in FIG. 3, a toner supply port 8m (toner supply unit) is opened above the groove portion 8f near to the first end portion E1. The toner supply port 8m is provided on the groove portion 8f at a position opposed in the X direction to a central position of the first notch portion 8h in the Y direction.

As shown in FIG. 4, a toner transfer tube 8p is provided and erected in an inner edge portion of the toner supply port 8m. The toner transfer tube 8p communicates with the toner supply port 8m.

At an upper end of the toner transfer tube 8p, a shutter 8n that opens and closes the opening of the toner transfer tube 8p is provided.

When the shutter 8n is opened, the toner supply tube 34 (not shown in FIG. 4) can be connected to the upper end of the toner transfer tube 8p. When the toner supply tube 34 is connected to the toner transfer tube 8p, as shown by a two-dot chain line in FIG. 3, the toner supply tube 34 is located above the toner supply port 8m.

The shutter 8n closes when the developing device 8 is detached from the image forming apparatus 100.

When the toner supply tube 34 is connected to the toner transfer tube 8p, the toner conveyed through the toner supply tube 34 is supplied to the developing device 8 through the toner transfer tube 8p and the toner supply port 8m. Through the toner supply port 8m, the conveyed toner is supplied onto the groove portion 8f.

For example, the toner supply tube 34 is connected to the toner cartridge 33Y (33M, 33C, or 33K) shown in FIG. 1. Through this toner supply tube 34, the toner of the same color as the toner contained in the developer 12y (12m, 12c, or 12k) is supplied to the developer 12y (12m, 12c, or 12k).

The toner supplied from the toner supply tube 34 drops on the groove portion 8f at a position opposed in the X direction to a central position of the first notch portion 8h in the Y direction. The toner after dropping on the groove portion 8f flows in the groove portion 8g from the groove portion 8f along with the developer 12 through the first notch portion 8h.

The toner supply amount is controlled by controlling the act of the toner conveying mechanism by the body control unit 6. For example, when the output of a toner density sensor (not shown) provided in the developing device 8 decreases, the body control unit 6 drives the toner conveying mechanism so as to compensate for the decreased amount.

As shown in FIG. 2, the first stirring screw 10 and the second stirring screw 11 are disposed inside the groove portions 8f and 8g of the developer storage container 8a, respectively.

As shown in FIG. 3, each of the first stirring screw 10 and the second stirring screw 11 extends in the Y direction.

The first stirring screw 10 is disposed parallel to the magnet roller 9. The first stirring screw 10 conveys the developer 12 in the groove portion 8f in the Y1 direction (first direction).

As shown in FIGS. 5 and 6, the first stirring screw 10 includes a rotating shaft 10a, a first protrusive ridge 10b (protrusive ridge), and a second protrusive ridge 10c (protrusive ridge).

As shown in FIG. 3, the rotating shaft 10a extends straight in the Y direction. A first end portion e1 and a second end portion e2 of the rotating shaft 10a are supported rotatably by bearing portions provided in the developer storage container 8a. Here, the first end portion e1 is an end portion in the Y1 direction of the rotating shaft 10a. The second end portion e2 is an end portion in the Y2 direction of the rotating shaft 10a.

The rotating shaft 10a can rotate around the central axis line O11 (see FIG. 2) of the rotating shaft 10a.

A gear 10n is provided in the second end portion e2 of the rotating shaft 10a.

The gear 10n is connected to a motor (not shown) through a transmission mechanism (not shown).

The motor that drives the first stirring screw 10 may be a developing motor or a motor other than a developing motor. In this embodiment, as one example, the first stirring screw 10 is driven by a developing motor. The rotational speed of the first stirring screw 10 has a certain relationship determined according to a transmission gear ratio of the transmission mechanism with respect to the developing linear speed.

In this embodiment, the first stirring screw 10 is rotated counterclockwise in FIG. 2 (left-handed when seen in the Y2 direction, see the arrow R1 in FIG. 2).

The first protrusive ridge 10b is formed in a spiral shape on an outer circumferential portion of the rotating shaft 10a. For example, the first protrusive ridge 10b is formed along a helical line with a fixed lead angle. The turning direction of the first protrusive ridge 10b is, for example, a left-hand direction.

However, in the first protrusive ridge 10b, a notch Nt is formed at a plurality of sites in the extending direction. The shape of the first protrusive ridge 10b excluding the notch Nt is not particularly limited as long as the developer 12 in the groove portion 8f can be conveyed in the Y2 direction according to the rotating direction of the rotating shaft 10a.

A detailed shape and the like of the notch Nt will be described later.

The second protrusive ridge 10c is formed in a spiral shape on an outer circumferential portion of the rotating shaft 10a between the pitches of the first protrusive ridge 10b. The second protrusive ridge 10c is formed in parallel to the first protrusive ridge 10b along a helical line with the same lead angle as that of the first protrusive ridge 10b. The second protrusive ridge 10c is provided at a position equidistant from the first protrusive ridge 10b adjacent thereto in the Y direction.

As shown in FIG. 2, the second protrusive ridge 10c in this embodiment is formed at a position rotationally symmetrical by 180° to the first protrusive ridge 10b with respect to the central axis line O10 in a cross section orthogonal to the central axis line O10. The cross-sectional shape of the second protrusive ridge 10c is the same as the cross-sectional shape of the first protrusive ridge 10b in a region excluding the notch Nt.

In the second protrusive ridge 10c, the notch Nt may be formed in the same manner as in the first protrusive ridge 10b. However, in this embodiment, as one example, the notch Nt is not formed in the second protrusive ridge 10c.

In the example shown in FIG. 5, the first protrusive ridge 10b is a spiral screw which rotates ten times in the Y2 direction. The turning direction of the first protrusive ridge 10b is left-handed (counterclockwise) when seen in the Y2 direction.

Hereinafter, with respect to a unit screw obtained by dividing the first protrusive ridge 10b for each turning pitch, the expression of “the n-th portion Sn” (provided that n=1, . . . , or 10, the same also applies hereinbelow) is used in some cases. For example, the first portion S1 represents a unit screw which is the nearest to the Y1 direction side in the first protrusive ridge 10b. When k is assumed to be an integer of 1 or more and 9 or less, the (k+1)-th portion S (k+1) is adjacent to the k-th portion Sk in the Y2 direction.

The n-th portion Sn starts at a point P (n−1) on the outer circumference of the first protrusive ridge 10b and ends at a point Pn on the outer circumference of the first protrusive ridge 10b. The respective points Pn are aligned on a straight line parallel to the central axis line O10.

Hereinafter, the position on the outer circumference of the first protrusive ridge 10b is represented by a turning angle θ. For example, the positions of the points P1, P2, and P3 are represented by θ=0°, θ=360°, and θ=720°, respectively. Further, the position on the outer circumferential line of the n-th portion Sn is represented by a phase ϕ (provided that 0°<ϕ<360°). The phase ϕ is represented by ϕ=θ−{360°×(n−1)}.

As shown in FIG. 6, on the outer circumference of the n-th portion Sn, an intermediate point between the point P(n−1) and the point Pn is referred to as “point Qn” in some cases. The phase ϕ of the point Qn is 180°.

In the following Table 1, the arrangement of the notches Nt is shown.

TABLE 1

| | | | phase ϕ |
|---|---|---|---|
| n | area | notch Nt | (°) |
| 1 | P0-Q1-P1 | without | — |
| 2 | P1-Q2-P2 | Nta | 315 |
| 3 | P2-Q3-P3 | Ntb | 135 |
| 4 | P3-Q4-P4 | without | — |
| 5 | P4-Q5-P5 | Nta | 315 |
| 6 | P5-Q6-P6 | Ntb | 135 |
| 7 | P6-Q7-P7 | without | — |
| 8 | P7-Q8-P8 | Nta | 315 |
| 9 | P8-Q9-P9 | Ntb | 135 |
| 10 | P9-Q10-P10 | without | — |

As shown in Table 1, in this embodiment, the notch Nt is formed in each of the second portion S2, the third portion S3, the fifth portion S5, the sixth portion S6, the eighth portion S8, and the ninth portion S9. The notch Nt is composed of two types: a notch Nta (see FIG. 5) and a notch Ntb (see FIG. 6).

The notch Nta is formed at a position where the phase is 315° in the second portion S2, the fifth portion S5, and the eighth portion S8. FIG. 7A is a cross-sectional view orthogonal to the central axis line O10 including the notch Nta. The symbol i in the drawing denotes 2, 5, or 8. FIG. 7A corresponds to a C2-C2 cross section, a C5-C5 cross section, or a C8-C8 cross section in FIG. 5.

As shown in FIG. 7A, the phase of the notch Nta is a phase of a central axis line Aa of the notch Nta.

The notch Nta is a recessed portion composed of a bottom face 10d, a first inner face 10e, and a second inner face 10f on the first protrusive ridge 10b.

The bottom face 10d is a curved face formed by intersecting a cylindrical face having a radius r with the central axis line O10 as the center with the first protrusive ridge 10b. Here, the radius r is larger than the radius Ra of the rotating shaft 10a and smaller than the outer radius Rb of the first protrusive ridge 10b (provided that Rb>Ra). A specific magnitude of r is determined according to the balance between the stirring performance and the conveying performance for the developer 12 required for the first stirring screw 10.

The first inner face 10e is a flat plane that includes the central axis line O10 and is formed by intersecting a flat plane having a phase of 270° with the first protrusive ridge 10b up to the bottom face 10d.

The second inner face 10f is a flat plane that includes the central axis line O10 and is formed by intersecting a flat plane having a phase of 0° with the first protrusive ridge 10b up to the bottom face 10d.

Therefore, the notch Nta has a shape in which the outer circumferential portion of the first protrusive ridge 10b is notched in a fan-like shape having a central angle of 90° when seen in the Y2 direction.

The depth of the notch Nta is a fixed value (Rb-r).

As shown in Table 1, the notch Ntb is formed at a position where the phase is 135° in the third portion S3, the sixth portion S6, and the ninth portion S9. FIG. 7B is a cross-sectional view orthogonal to the central axis line O10 including the notch Ntb. The symbol j in the drawing denotes 3, 6, or 9. FIG. 7B corresponds to a D3-D3 cross section, a D6-D6 cross section, or a D9-D9 cross section in FIG. 5.

As shown in FIG. 7B, the phase of the notch Ntb is a phase of a central axis line Ab of the notch Ntb.

The notch Ntb may have a different shape from the notch Nta. However, in this embodiment, as one example, the notch Ntb has the same shape as the notch Nta.

The notch Ntb is a recessed portion on the first protrusive ridge 10b in the same manner as the notch Nta. The notch Ntb includes a bottom face 10g, a first inner face 10h, and a second inner face 10i corresponding to the bottom face 10d, the first inner face 10e, and the second inner face 10f of the notch Nta, respectively.

The bottom face 10g, the first inner face 10h, and the second inner face 10i are the same faces as the bottom face 10d, the first inner face 10e, and the second inner face 10f, respectively, except that the formed phase is different by 180°.

That is, the depth of the notch Ntb is equal to that of the notch Nta. The opening length of the notch Ntb in the extending direction of the first protrusive ridge 10b is the same as the opening length of the notch Nta.

The notch Nt in this embodiment is configured to have a repetitive pattern in which the notches Nta and Ntb are alternately lined up in this order in the axial direction of the first stirring screw 10 (Y direction). Therefore, the phases ϕ of the plurality of notches Nt are 315° and 135° which alternate in this order. A phase difference between the notch Nta and the notch Ntb adjacent to each other in the axial direction is 180° and constant.

Further, the plurality of notches Nt are configured such that a pair of notches Nta and Ntb is sandwiched among the first portion S1, the fourth portion S4, the seventh portion S7, and the tenth portion S10 where the notch Nt is not formed. Therefore, the first protrusive ridge 10b has a repetitive pattern in which, provided that k=1, 4, or 7, a k-th portion Sk where the notch Nt is not formed, a (k+1)-th portion S(k+1) where the notch Nta is formed, and a (k+2)-th portion S(k+2) where the notch Ntb is formed are lined up.

Therefore, a distance between the notches Nta and Ntb sandwiching the k-th portion Sk therebetween is longer than a distance between the notches Nta and Ntb in the (k+1)-th portion S(k+1) and the (k+2)-th portion S(k+2).

In the first stirring screw 10, the rotating shaft 10a, the first protrusive ridge 10b, and the second protrusive ridge 10c may be formed of the same material or different materials. For example, in this embodiment, the rotating shaft 10a, the first protrusive ridge 10b, and the second protrusive ridge 10c are integrally formed by resin molding.

As shown in FIG. 3, the second stirring screw 11 is adjacent to the first stirring screw 10 in the X2 direction with the first partition 8d interposed therebetween. The second stirring screw 11 is disposed parallel to the first stirring screw 10. Therefore, the second stirring screw 11 is disposed parallel to the magnet roller 9 at a position farther apart from the magnet roller 9 than the first stirring screw 10.

The second stirring screw 11 conveys the developer 12 in the groove portion 8g in the Y2 direction (second direction).

The second stirring screw 11 includes a rotating shaft 11a and a screw 11b.

The rotating shaft 11a extends straight in the Y direction. Both end portions of the rotating shaft 11a are supported rotatably by bearing portions provided in the developer storage container 8a.

The rotating shaft 11a can rotate around the central axis line O11 (see FIG. 2) of the rotating shaft 11a.

A gear 11c is provided in the second end portion e2 of the rotating shaft 11a.

The gear 11c is connected to a motor (not shown) through a transmission mechanism (not shown).

The motor that drives the second stirring screw 11 may be a developing motor or a motor other than a developing motor. In this embodiment, as one example, the second stirring screw 11 is driven by a developing motor. The rotational speed of the second stirring screw 11 has a certain relationship determined according to a transmission gear ratio of the transmission mechanism with respect to the developing linear speed.

As shown in FIG. 3, the screw 11b is formed in a spiral shape on an outer circumferential portion of the rotating shaft 11a. The shape of the screw 11b is not particularly limited as long as the developer 12 in the groove portion 8g can be conveyed in the Y2 direction according to the rotating direction of the rotating shaft 11a. For example, in this embodiment, the screw 11b is a single threaded spiral screw.

In the second stirring screw 11, the rotating shaft 11a and the screw 11b may be formed of the same material or different materials. For example, in this embodiment, the rotating shaft 11a and the screw 11b are integrally formed by resin molding.

Next, an act of the image forming apparatus 100 will be described while focusing on an action of the developing device 8.

First, an act of image formation of the image forming apparatus 100 will be briefly described.

In the image forming apparatus 100 shown in FIG. 1, image formation is started by an operation of the control panel 1 or an external signal. Image information is sent to the printer unit 3 by reading an object to be copied by the scanner unit 2 or is externally sent to the printer unit 3.

The printer unit 3 feeds the sheet S from the sheet feed unit 4 to the resist roller 24. The sheet S to be fed from the sheet feed unit 4 is selected by the body control unit 6 based on an operation of the control panel 1 or an external signal.

When an operation input for image formation is performed from the control panel 1, the body control unit 6 performs control for starting paper feed from a paper feed cassette and image formation.

The image forming units 25Y, 25M, 25C, and 25K form electrostatic latent images on the respective photoconductive drums 7 based on the image information according to the respective colors. The respective electrostatic latent images are developed by the developing devices 8, respectively. Therefore, toner images corresponding to the electrostatic latent images are formed on the surfaces of the respective photoconductive drums 7.

The respective toner images are primarily transferred to the intermediate transfer belt 27 by the respective transfer rollers. At this time, the transfer timing is appropriately shifted according to the arrangement positions of the image forming units 25Y, 25M, 25C, and 25K. Therefore, the respective toner images are sequentially overlapped with one another with the movement of the intermediate transfer belt 27 without causing a color shift and sent to the transfer unit 28.

On the other hand, the sheet S is fed and sent from the resist roller 24 to the transfer unit 28. The toner images after reaching the transfer unit 28 are secondarily transferred to the sheet S. The secondarily transferred toner images are fixed to the sheet S by the fixing device 29.

On the intermediate transfer belt 27, a transfer residual toner remains. The transfer residual toner is a toner which cannot be transferred onto the sheet S by the transfer unit 28. The transfer residual toner is scraped off by the transfer belt cleaning unit 35. The intermediate transfer belt 27 is cleaned so as to be made reusable.

Next, an act of the developing device 8 will be described while focusing on an act of stirring the developer 12.

FIG. 8 is a schematic cross-sectional view in the axial direction illustrating an act of the developing device of the embodiment.

While performing image formation by the image forming apparatus 100, in the developing device 8, the first stirring screw 10 and the second stirring screw 11 are rotated by a motor.

The first stirring screw 10 conveys the developer 12 in the groove portion 8f in the Y1 direction while stirring the developer 12. The developer 12 in the groove portion 8f is conveyed from the second notch portion 8i to the first notch portion 8h.

The second stirring screw 11 conveys the developer 12 in the groove portion 8g in the Y2 direction while stirring the developer 12. The developer 12 in the groove portion 8g is conveyed from the first notch portion 8h to the second notch portion 8i.

The conveyance amounts of the first stirring screw 10 and the second stirring screw 11 are equal to each other. Therefore, the developer 12 after reaching the first notch portion 8h moves to the groove portion 8g through the first notch portion 8h. The developer 12 after reaching the second notch portion 8i moves to the groove portion 8f through the second notch portion 8i. In this manner, the developer 12 is circulated and conveyed in the developer storage container 8a.

As a result, a substantially uniform flow occurs in the developer 12 in the groove portion 8f opposed to the magnet roller 9. To the developer 12 that moves to the groove portion 8f, the uniformly charged toner is adhered by the rotation of the second stirring screw 11.

As shown in FIG. 2, the developer 12 in the vicinity of the magnet roller 9 is drawn up on the developing sleeve 9a by the magnetic force of the magnet 9b. The developer 12 adsorbed on the surface of the developing sleeve 9a rotates along with the developing sleeve 9a. The developer 12 forms a magnetic brush at a position opposed to the photoconductive drum 7 according to the magnetic force distribution of the magnet 9b.

When a developing bias is applied to the toner in the magnetic brush by the body control unit 6, the toner is electrostatically adsorbed on the electrostatic latent image on the photoconductive drum 7. According to this, the electrostatic latent image on the photoconductive drum 7 is developed with the toner.

The developer 12 in which part of the toner is lost moves in the first storage chamber 8j with the rotation of the developing sleeve 9a and drops on the groove portion 8f from the developing sleeve 9a according to the magnetic force distribution of the magnet 9b.

When image formation proceeds, the developer 12 in which the toner is reduced is mixed in the developer 12 conveyed by the first stirring screw 10. The developers 12 having different toner adhesion amounts are moved in the Y1 direction and also stirred by the first stirring screw 10.

In this manner, when image formation is started, the toner density of the developer 12 in the groove portion 8f decreases.

The body control unit 6 monitors the toner density by the toner density sensor (not shown). The body control unit 6 controls toner supply as needed. According to this, the toner is supplied from the toner cartridge through the toner supply tube 34 and the toner supply port 8m.

The supplied toner moves from the groove portion 8f to the end portion in the Y1 direction of the groove portion 8g along with the developer 12 that moves to the groove portion 8f through the first notch portion 8h.

The second stirring screw 11 conveys the developer 12 and the toner in the groove portion 8g in the Y2 direction while stirring the developer 12 and the toner. The toner is adsorbed on the carrier of the developer 12 by triboelectric charging during stirring.

The developer 12 is further conveyed in the Y2 direction while being stirred by the second stirring screw 11.

In this manner, in the developer storage container 8a, a flow of the developer 12 that circulates in the groove portions 8f and 8g is formed.

The developer 12 flowing in the groove portion 8f may not be stirred so vigorously as in the groove portion 8g because the developer 12 sufficiently stirred in the groove portion 8g flows therein. However, in the groove portion 8f, the toner is consumed accompanying image formation. The developer 12 needs to be continuously stirred to such an extent that unevenness does not occur in the toner distribution in the developer 12.

As shown in FIG. 8, in the groove portion 8f, when the first stirring screw 10 rotates, the developer 12 is conveyed along a spiral groove between the first protrusive ridge 10b and the second protrusive ridge 10c adjacent to each other in the axial direction (Y direction) by the action of the first protrusive ridge 10b and the second protrusive ridge 10c (see white arrows in the drawing). The developer 12 as a whole is conveyed in the Y1 direction.

However, in this embodiment, a plurality of notches Nt are formed in the first protrusive ridge 10b. In the first protrusive ridge 10b in which the notch Nt is formed, a conveying force in the turning direction of the first protrusive ridge 10b is decreased as compared with the first protrusive ridge 10b in which the notch Nt is not formed. However, a pressing force from the developer 12 on the upstream side in the conveying direction acts thereon, and therefore, part of the developer 12 in the vicinity of the notch Nt goes forward in the turning direction of the first stirring screw 10, and the rest of the developer 12 passes through the notch Nt in the Y1 direction.

In this manner, slowing down of the speed of the developer 12, branching of the flow of the developer 12, and mixing in another flow path occur in the vicinity of the notch Nt. As a result, stirring of the developer 12 is promoted.

Accordingly, the notch Nt in the first stirring screw 10 promotes stirring by forming a linear speed difference in a tip portion in the protruding direction of the first protrusive ridge 10b.

The conveying performance of the first protrusive ridge 10b in a region where the notch Nt is formed (hereinafter referred to as the “conveying performance in the notch Nt”) becomes higher as the height of the bottom face 10d or 10g is higher. On the other hand, the stirring performance of the first protrusive ridge 10b in a region where the notch Nt is formed (hereinafter referred to as the “stirring performance in the notch Nt”) becomes higher as the height of the bottom face 10d or 10g is lower.

The conveying performance in the notch Nt becomes higher as the length of the notch Nt in the extending direction of the first protrusive ridge 10b is shorter. On the other hand, the stirring performance in the notch Nt becomes higher as the length of the notch Nt in the extending direction of the first protrusive ridge 10b is longer.

On the other hand, the notch Nt deteriorates the flexural rigidity of the first stirring screw 10. Therefore, the first stirring screw 10 easily bends accompanying the rotation of the first stirring screw 10. When the first stirring screw 10 bends during rotation, the parallelism of the first stirring screw 10 with respect to the magnet roller 9 is reduced. Due to this, unevenness occurs in the adhesion amount of the developer 12 to the developing sleeve 9a, and as a result, uneven development is likely to occur.

The notch Nt is preferably formed in consideration of the bending deformation of the first stirring screw 10. The notch Nt is particularly preferably formed so that the bias in the circumferential direction of the first stirring screw 10 is decreased from the viewpoint that anisotropy in the flexural rigidity can be suppressed.

In this embodiment, the notches Nta and Ntb having a mutual phase difference of 180° are adjacent to each other in a length twice as long as the turning pitch in the axial direction. Adjacent thereto, the first protrusive ridge 10b in which the notch Nt is not formed extends in the length of the turning pitch. Further, in the first stirring screw 10, such a repetitive pattern is repeated three times in the axial direction.

According to such a configuration, the bias in the circumferential direction is decreased in the plurality of notches Nt of the first stirring screw 10.

Further, a region having high stirring performance and a region having high conveying performance alternate with each other in the axial direction, and therefore, the bias of the developer 12 due to stirring is dispersed in the axial direction.

In addition, in this embodiment, the notch Nt is not formed in the second protrusive ridge 10c. Since the second protrusive ridge 10c having constant conveying performance is continuous in the axial direction, the uniformity of the conveying performance in the axial direction is improved.

As described above, according to the image forming apparatus 100 and the developing device 8 of this embodiment, since the first stirring screw 10 is included, the stirring performance for the developer 12 is improved. Accordingly, the developer 12 to be adhered to the magnet roller 9 is stably conveyed while being favorably stirred, and therefore, uneven development is reduced.

In particular, according to this embodiment, the first stirring screw 10 having favorable stirring performance and less bias in the flexural rigidity in the axial direction can be provided. Due to this, uneven development caused by bending deformation of the first stirring screw 10 can be suppressed.

According to at least one embodiment described above, the developing device and the image forming apparatus capable of improving the stirring performance for the developer can be provided.

Hereinafter, modifications of the above-mentioned embodiments will be described with reference to the drawings.

### First Modification

A developing device of a first modification will be described.

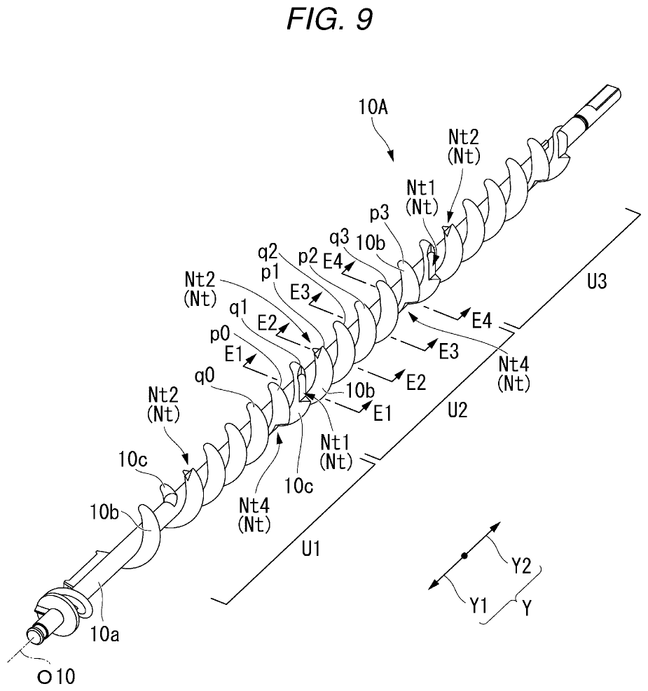

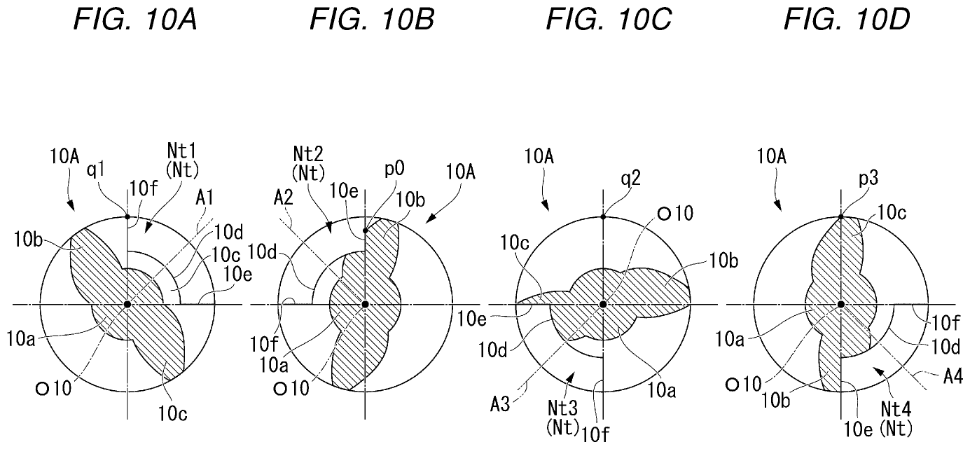

FIG. 9 is a schematic perspective view showing an example of a first stirring screw of the first modification of the embodiment. FIGS. 10A to 10D are schematic cross-sectional views in FIG. 9. FIG. 10A is an E1-E1 cross-sectional view in FIG. 9. Similarly, FIG. 10B is an E2-E2 cross-sectional view, FIG. 10C is an E3-E3 cross-sectional view, and FIG. 10D is an E4-E4 cross-sectional view.

A developing device 8A of the first modification shown in FIGS. 1 and 2 includes a first stirring screw 10A (see FIG. 2) in place of the first stirring screw 10 of the developing device 8 of the embodiment.

The developing device 8A can be used in the image forming apparatus 100 in place of the developing device 8.

Hereinafter, different points from the embodiment will be mainly described.

As shown in FIG. 9, the first stirring screw 10A is different from the first stirring screw 10 in the number of notches Nt and sites where the notches Nt are formed.

The notches Nt in the first stirring screw 10A have a repetitive pattern different from the embodiment. According to this repetitive pattern, the first stirring screw 10A is composed of a first portion U1, a second portion U2, and a third portion U3.

Hereinafter, arrangement of the notches Nt in the second portion U2 will be described with reference to points p0 to p3 and points q0 to q3 shown in FIG. 9. Here, the points p0 to p3 are a four-point sequence having a phase of 0° of the first protrusive ridge 10b continuously arranged in the Y2 direction. The points q0 to q3 are a four-point sequence having a phase of 0° of the second protrusive ridge 10c continuously arranged in the Y2 direction. However, the point p0 is a point adjacent to the point q1 in the Y2 direction.

The second portion U2 is composed of an area including the points p0, q1, p1, q2, p2, q3, and p3.

In the following Table 2, arrangement with respect to the second portion U2 is shown.

TABLE 2

| protrusive ridge | area | notch Nt | phase ϕ (°) |
|---|---|---|---|
| first protrusive ridge 10b | p0-p1 | without | — |
| second protrusive ridge 10c | q0-q1 | Nt1 | 315 |
| first protrusive ridge 10b | p1-p2 | Nt2 | 45 |
| second protrusive ridge 10c | q1-q2 | Nt3 | 135 |
| first protrusive ridge 10b | p2-p3 | Nt4 | 225 |
| second protrusive ridge 10c | q2-q3 | without | — |

As shown in Table 2, the notch Nt of the first modification is composed of four types: notches Nt1, Nt2, Nt3, and Nt4. However, in FIG. 9, the notch Nt3 is not shown due to the projection direction.

The notches Nt1, Nt2, Nt3, and Nt4 all have the same shape as the notch Nta of the embodiment.

As shown in Table 2, the notch Nt1 is formed at a position where the phase is 315° in the area q0-q1 of the second protrusive ridge 10c. FIG. 10A is a cross-sectional view orthogonal to the central axis line O10 including the notch Nt1. As shown in FIG. 10A, the phase of the notch Nt1 is a phase of a central axis line A1 of the notch Nt1 in the area q0-q1.

The notch Nt2 is formed at a position where the phase is 45° in the area p1-p2 of the first protrusive ridge 10b. FIG. 10B is a cross-sectional view orthogonal to the central axis line O10 including the notch Nt2. As shown in FIG. 10B, the phase of the notch Nt2 is a phase of a central axis line A2 of the notch Nt2 in the area p1-p2.

The notch Nt3 is formed at a position where the phase is 135° in the area q1-q2 of the second protrusive ridge 10c. FIG. 10C is a cross-sectional view orthogonal to the central axis line O10 including the notch Nt3. As shown in FIG. 10C, the phase of the notch Nt3 is a phase of a central axis line A3 of the notch Nt3 in the area q1-q2.

The notch Nt4 is formed at a position where the phase is 225° in the area p2-p3 of the first protrusive ridge 10b. FIG. 10D is a cross-sectional view orthogonal to the central axis line O10 including the notch Nt4. As shown in FIG. 10D, the phase of the notch Nt4 is a phase of a central axis line A4 of the notch Nt4 in the area p2-p3.

In order to form the above-mentioned four types of notches Nt in the second portion U2, the notch Nt is not formed in each of the area p0-p1 and the area q2-q3.

The first portion U1 has the same configuration as the second portion U2 except that the notch Nt1 is not formed due to the start position of the second protrusive ridge 10c.

The third portion U3 has the same configuration as the second portion U2.

In this manner, in the first stirring screw 10A, the arrangement pattern of the notches Nt in the second portion U2 is repeated 2 and 3/4 times in the axial direction.

In the first stirring screw 10A, the mutual phase difference between the notches Nt adjacent to each other in the axial direction is 90°.

The arrangement of the notches Nt in the first protrusive ridge 10b of this modification is the same as the arrangement in the first protrusive ridge 10b of the embodiment. For example, the notches Nta and Ntb of the embodiment correspond to the notches Nt2 and Nt4 of this modification, respectively.

The arrangement of the notches Nt in the second protrusive ridge 10c of this modification is the same as the arrangement in the first protrusive ridge 10b except that the phase is different by 90°.

According to the developing device 8A, the first stirring screw 10A includes the plurality of notches Nt whose phases are shifted by 90° in the axial direction, and therefore, in the same manner as the developing device 8 of the embodiment, the stirring performance for the developer 12 is improved. According to this, uneven development is reduced.

In particular, in this modification, the number of notches Nt per unit length is increased as compared with the embodiment, and therefore, the stirring performance is further improved.

In this modification, an example in which the depth and the length of each notch Nt are the same as those of the notch Nt of the embodiment is described. However, the depth and the length of each notch Nt may be different from those of the notch Nt of the embodiment. For example, by shortening the length of the notch Nt or reducing the depth of the notch Nt, the flexural rigidity of the first stirring screw 10A can be made equal to that of the first stirring screw 10.

Second Modification

A developing device of a second modification will be described.

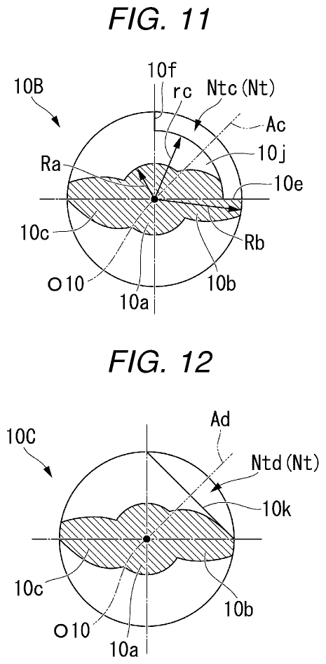

FIG. 11 is a schematic cross-sectional view showing an example of a first stirring screw of the second modification of the embodiment.

A developing device 8B of the second modification shown in FIGS. 1 and 2 includes a first stirring screw 10B (see FIG. 2) in place of the first stirring screw 10 of the developing device 8 of the embodiment.

As shown in FIG. 11, in the first stirring screw 10B, a plurality of notches Ntc are formed in the first protrusive ridge 10b of the first stirring screw 10 of the embodiment as the notches Nt. In FIG. 11, as shown by the central axis line Ac, the notch Ntc formed at a position where the phase is 315° is shown.

The developing device 8B can be used in the image forming apparatus 100 in place of the developing device 8.

Hereinafter, different points from the embodiment will be mainly described.

The notch Ntc includes a bottom face 10j in place of the bottom face 10d of the notch Nta of the embodiment. The bottom face 10j is a curved face formed by intersecting a cylindrical face having a radius rc (provided that r<rc<Rb) with the central axis line O10 as the center with the first protrusive ridge 10b.

Therefore, the stirring performance of the notch Ntc is decreased as compared with that of the notch Nta.

In this modification, in order to compensate for the decrease in the stirring performance, the notch Ntc is formed in each n-th portion Sn. In the following Table 3, the arrangement of the notches Ntc is shown.

TABLE 3

| n | area | notch Nt | phase ϕ (°) |
|---|---|---|---|
| 1 | P0-Q1-P1 | Ntc | 315 |
| 2 | P1-Q2-P2 | Ntc | 135 |
| 3 | P2-Q3-P3 | Ntc | 315 |
| 4 | P3-Q4-P4 | Ntc | 135 |
| 5 | P4-Q5-P5 | Ntc | 315 |
| 6 | P5-Q6-P6 | Ntc | 135 |
| 7 | P6-Q7-P7 | Ntc | 315 |
| 8 | P7-Q8-P8 | Ntc | 135 |
| 9 | P8-Q9-P9 | Ntc | 315 |
| 10 | P9-Q10-P10 | Ntc | 135 |

As shown in Table 3, in this modification, the notch Nt is composed of the notch Ntc. The notch Ntc is formed at a position where the phase is 315° in an n-th portion Sn wherein n is an even number. The notch Ntc is formed at a position where the phase is 135° in an n-th portion Sn wherein n is an odd number.

Therefore, each notch Ntc is continuously disposed in the axial direction for each turning pitch. The phase differences between the notches Ntc adjacent to each other are all 180°.

According to such an arrangement of the notches Ntc, the uniformity of the stirring performance is improved throughout the axial direction of the first stirring screw 10B. In this modification, an n-th portion Sn where the notch Ntc is not formed is not present, and therefore, the flexural rigidity may be deteriorated as compared with the embodiment. Due to this, in this modification, by reducing the depth of each notch Ntc, the flexural rigidity is improved. Accordingly, even if the stirring performance is improved, the same flexural rigidity as in the embodiment can be ensured.

According to the developing device 8B, the first stirring screw 10B includes the notches Ntc, and therefore, in the same manner as the developing device 8 of the embodiment, the stirring performance for the developer 12 is improved. Accordingly, uneven development is reduced.

This modification is an example of a case where the notch Nt may be provided in each n-th portion Sn.

Third Modification

A developing device of a third modification will be described.

FIG. 12 is a schematic cross-sectional view showing an example of a first stirring screw of the third modification of the embodiment.

A developing device 8C of the third modification shown in FIGS. 1 and 2 includes a first stirring screw 10C (see FIG. 2) in place of the first stirring screw 10 of the developing device 8 of the embodiment.

As shown in FIG. 12, in the first stirring screw 10C, in place of the notches Nta and Ntb of the first stirring screw 10 of the embodiment, notches Ntd are formed at positions of the same phases as the respective notches Nta and Ntb. In FIG. 12, as shown by the central axis line Ad, the notch Ntd formed at a position where the phase is 315° is shown.

The developing device 8C can be used in the image forming apparatus 100 in place of the developing device 8.

Hereinafter, different points from the embodiment will be mainly described.

The notch Ntd is constituted by an inclined plane 10k. The inclined plane 10k has a shape in which the first protrusive ridge 10b is cut off with a flat plane that is a flat plane parallel to the central axis line O10 and is orthogonal to the diameter of the first stirring screw 10C within a phase range of 90°.

Therefore, the depth of the notch Ntd gradually increases from both end portions in the extending direction of the first protrusive ridge 10b to an intersection with the central axis line Ac.

According to the developing device 8C, the first stirring screw 10C includes the notches Ntd, and therefore, in the same manner as the developing device 8 of the embodiment, the stirring performance for the developer 12 is improved. Accordingly, uneven development is reduced.

This modification is an example of a case where the depth of the notch Nt may gradually changes inside the notch Nt.

Fourth Modification

A developing device of a fourth modification will be described.

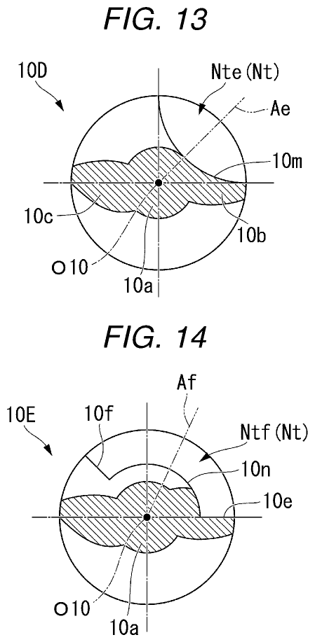

FIG. 13 is a schematic cross-sectional view showing an example of a first stirring screw of the fourth modification of the embodiment.

A developing device 8D of the fourth modification shown in FIGS. 1 and 2 includes a first stirring screw 10D (see FIG. 2) in place of the first stirring screw 10 of the developing device 8 of the embodiment.

As shown in FIG. 13, in the first stirring screw 10D, in place of the notches Nta and Ntb of the first stirring screw 10 of the embodiment, notches Nte are formed at positions of the same phases as the respective notches Nta and Ntb. In FIG. 13, as shown by the central axis line Ae, the notch Nte formed at a position where the phase is 315° is shown.

The developing device 8D can be used in the image forming apparatus 100 in place of the developing device 8.

Hereinafter, different points from the embodiment will be mainly described.

The notch Nte is constituted by a curved face 10m. The curved face 10m is a recessed portion in which the first protrusive ridge 10b is cut off with a cylindrical plane protruding to the inside in the radial direction within a phase range of 90°.

Therefore, the depth of the notch Nte gradually increases from both end portions in the extending direction of the first protrusive ridge 10b to an intersection with the central axis line Ae.

According to the developing device 8D, the first stirring screw 10D includes the notches Nte, and therefore, in the same manner as the developing device 8 of the embodiment, the stirring performance for the developer 12 is improved. Accordingly, uneven development is reduced.

This modification is an example of a case where the depth of the notch Nt may gradually changes inside the notch Nt.

Fifth Modification

A developing device of a fifth modification will be described.

FIG. 14 is a schematic cross-sectional view showing an example of a first stirring screw of the fifth modification of the embodiment.

A developing device 8E of the fifth modification shown in FIGS. 1 and 2 includes a first stirring screw 10E (see FIG. 2) in place of the first stirring screw 10 of the developing device 8 of the embodiment.

As shown in FIG. 14, in the first stirring screw 10E, in place of the notches Nta and Ntb of the first stirring screw 10 of the embodiment, notches Ntf are formed at positions of the same phases as the respective notches Nta and Ntb. The phase of the arrangement position of the notch Ntf is defined by the position of the central axis line Af of the notch Ntf in the same manner as in the embodiment.

The developing device 8E can be used in the image forming apparatus 100 in place of the developing device 8.

Hereinafter, different points from the embodiment will be mainly described.

The notch Ntf is different from the notch Nta in the opening length thereof. For example, in the example shown in FIG. 14, the opening length of the notch Ntf is longer than the opening length of the notch Nta. For example, the length of the notch Ntf may be a length corresponding to a phase of 120°. However, the opening length of the notch Ntf may be shorter than the opening length of the notch Nta.

The notch Ntf has different stirring performance from the notch Nta depending on the difference in the opening length.

According to the developing device 8E, the first stirring screw 10E includes the notches Ntf, and therefore, in the same manner as the developing device 8 of the embodiment, the stirring performance for the developer 12 is improved. Accordingly, uneven development is reduced.

Hereinabove, modifications of various notches Nt are described in the first to fifth modifications. The notches Nt in the respective modifications can be used by being appropriately combined with the above-mentioned embodiments and modifications.

Further, hereinabove, an example of a case where one notch Nt is formed in the unit screw is described. However, one or more notches Nt may be formed in the unit screw.

Hereinabove, an example of a case where the phase difference between the notches Nt is 90° or 180° is described. However, the phase difference between the notches Nt is not limited to 90° or 180°, and may be, for example, 60°, 120°, or the like.

Other than in the operating examples, if any, or where otherwise indicated, all numbers, values and/or expressions referring to parameters, measurements, degrees, etc., used in the specification and claims are to be understood as modified in all instances by the term “about.”

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. A developing device, comprising:
a developer storage unit including a first storage chamber and a second storage chamber storing a developer and configured to circulate and convey the developer through a first opening and a second opening formed in both end portions in a longitudinal direction between the first storage chamber and the second storage chamber;
a magnet roller disposed extending in the longitudinal direction in an upper portion of the first storage chamber and configured to adsorb the developer;
a first stirring screw configured to convey the developer from the second opening to the first opening along the longitudinal direction, and the first stirring screw including a rotating shaft and a protrusive ridge, the rotating shaft being disposed along the longitudinal direction below the magnet roller inside the first storage chamber, the protrusive ridge spirally swirling around the rotating shaft, the protrusive ridge extending from the rotating shaft by a defined distance, a plurality of notches being formed in part of the protrusive ridge, the plurality of notches being formed at positions where the phases in the circumferential direction of the rotating shaft at respective central positions in the plurality of notches are shifted in the axial direction, a depth of the plurality of notches from a distal end of the protrusive ridge being less than the defined distance; and
a second stirring screw disposed parallel to the first stirring screw inside the second storage chamber, and configured to convey the developer from the first opening to the second opening along the longitudinal direction.

2. The device according to claim 1, wherein
a phase difference between the notches adjacent to each other in the axial direction among the plurality of notches is a fixed angle.

3. The device according to claim 2, wherein
the fixed angle is about 180°.

4. The device according to claim 1, wherein
the depth of each of the plurality of notches is constant.

5. The device according to claim 1, wherein
the opening lengths of the plurality of notches in the extending direction of the protrusive ridge are substantially the same.

6. The device according to claim 1, wherein
the arrangement of the plurality of notches has a repetitive pattern that is repeated two or more times in the axial direction.

7. The device according to claim 1, wherein
among the plurality of notches, the notches adjacent to each other in the axial direction are spaced apart farther than a turning pitch of the protrusive ridge in the axial direction.

8. The device according to claim 1, wherein
the protrusive ridge comprises two ridges.

9. The device according to claim 8, wherein
the plurality of notches are formed on only one of the protrusive ridges.

10. The device according to claim 8, wherein
the two ridges have a phase difference of about 60°, about 90°, about 120°, about 180°, or about 270°.

11. An image forming apparatus, comprising the developing device according to claim 1.

12. A method of processing a developer, comprising:
circulating and conveying the developer through a first opening and a second opening formed in both end portions in a longitudinal direction between a first storage chamber and a second storage chamber of a developer storage unit including the first storage chamber and the second storage chamber;
adsorbing the developer using a magnet roller disposed extending in the longitudinal direction in an upper portion of the first storage chamber;
conveying the developer from the second opening to the first opening along the longitudinal direction using a first stirring screw, the first stirring screw including a rotating shaft and a protrusive ridge, the rotating shaft being disposed along the longitudinal direction below the magnet roller inside the first storage chamber, the protrusive ridge spirally swirling around the rotating shaft, the protrusive ridge extending from the rotating shaft by a defined distance, a plurality of notches being formed in part of the protrusive ridge, the plurality of notches being formed at positions where the phases in the circumferential direction of the rotating shaft at respective central positions in the plurality of notches are shifted in the axial direction, a depth of the plurality of notches from a distal end of the protrusive ridge being less than the defined distance; and
conveying the developer from the first opening to the second opening along the longitudinal direction using a second stirring screw disposed parallel to the first stirring screw inside the second storage chamber.

13. The method according to claim 12, wherein
a phase difference between the notches adjacent to each other in the axial direction among the plurality of notches is a fixed angle.

14. The method according to claim 13, wherein
the fixed angle is about 180°.

15. The method according to claim 12, wherein
the depth of each of the plurality of notches is constant.

16. The method according to claim 12, wherein
the opening lengths of the plurality of notches in the extending direction of the protrusive ridge are substantially the same.

17. The method according to claim 12, wherein
the arrangement of the plurality of notches has a repetitive pattern that is repeated two or more times in the axial direction.

18. The method according to claim 12, wherein
among the plurality of notches, the notches adjacent to each other in the axial direction are spaced apart farther than a turning pitch of the protrusive ridge in the axial direction.

19. The method according to claim 12, wherein
the protrusive ridge comprises two ridges.

20. The method according to claim 19, wherein
the plurality of notches are formed on only one of the protrusive ridges.
